(19) United States
(12) Patent Application Publication
(10) Pub. No.: US 2008/0275158 A1
(43) Pub. Date: Nov. 6, 2008

(54) FOAM DESTABILIZED WATER BORNE FILM FORMING COMPOSITIONS

(75) Inventor: Michael R. Van de Mark, Rolla, MO (US)

Correspondence Address: SENNIGER POWERS LLP, 100 NORTH BROADWAY, 17TH FLOOR, ST LOUIS, MO, 63102, US

(73) Assignee: THE CURATORS OF THE UNIVERSITY OF MISSOURI, Columbia, MO (US)

(21) Appl. No.: 12/114,037

(22) Filed: May 2, 2008

Related U.S. Application Data
(60) Provisional application No. 60/927,255, filed on May 2, 2007.

(51) Int. Cl. C08K 5/10; A01P 15/00

(52) U.S. Cl. 523/122; 524/317

(57) ABSTRACT

A film-forming composition comprising a continuous aqueous phase and a dispersed phase, including a foam destabilizing additive comprising an ester, which additive helps lower the amount of foam formed and its subsequent stability and allows for more rapid air release.

### FIELD OF THE INVENTION

This invention generally relates to polyunsaturated ester aqueous film forming formulations and such formulations with foam destabilizing additives.

### BACKGROUND OF THE INVENTION

Aqueous dispersions of oils, chemicals, particulate polymer or emulsified liquid pre-polymers for use as agricultural sprays, cutting oils, paints, sealants, caulks, adhesives or other coatings are well-known, widely-used articles of commerce. The effectiveness of these dispersion are heavily influenced by the formation of unwanted foam. Many antifoaming or defoaming agents have been developed to alleviate this problem. Silicone and mineral oil type foam destabilizing additives have been very popular but can cause a reduction in adhesion, surface defects, or a weakening of the film. Foam destabilizing additives are used in two places in film forming compositions. The first is in the grind phase of production of pigmented coatings. Air is entrained during the dispersion of the pigments and the foam destabilizing additive helps break up the bubbles before they can become stabilized. The second is in the letdown phase where the air has been entrained during milling or the adding of the other components. Here the bubbles have formed and the additive breaks the bubbles up. The subsequent end user may also entrain air which if not destabilized will cause surface defects. This latter problem is analogous to the second type of problem and is solved by addition of the foam destabilizing additive during manufacture of the paint in the letdown.

Coalescent aids have been used in such aqueous dispersions to soften, i.e., plasticize, the particulate polymers and facilitate the formation of a continuous film with optimum film properties once the water has evaporated. In addition to increasing the ease of film formation, the coalescent aid also promotes subsequent improvements in film properties by coalescing the particulate polymers and liquid pre-polymers and forming an integral film at ambient temperatures. Without the coalescent aid, the films may crack and fail to adhere to the substrate surface when dry.

Coalescent aids are particularly helpful in assisting the formation of particulate polymer films possessing a high glass transition temperature, that is, the temperature which defines how easily the particles of the polymer diffuse at the temperature at which the film-forming composition is applied. The presence of coalescent aids in a particulate polymer film having a high glass transition temperature allows optimum film formation at ambient temperatures.

Various alcohol esters and ether alcohols have been proposed for use as coalescent aids. For example, U.S. Pat. No. 7,160,945 describes the use of a coalescing aid comprising an ester derived from a fatty acid of an oil of plant or animal origin, the ester having the formula RCOOX wherein R is hydrocarbyl or substituted hydrocarbyl and comprises at least two unsaturated carbon-carbon bonds and X is —C2H4OH, —C2H4OC2H 4OH, —C3H6OH, or —C3H6OC3H6OH, whereby air oxidation of the additive causes oligomerization of the additive in the presence of air.

Two of the more widely used coalescent aids are ethylene glycol monobutyl ether (EB, Union Carbide) and 2,2,4-trimethyl-1,3 pentanediol monobutyrate (TEXANOL.R™., Eastman Kodak). While EB and TEXANOL.R™. are useful in facilitating film formation of particulate polymer coatings with high glass transition temperatures and are even useful in facilitating film formation of particulate polymer coatings with low glass transition temperatures if they are being applied at a temperature that is lower than ambient temperature, they are relatively volatile and, as a result, are currently classified as VOCs (volatile organic compounds).

### SUMMARY OF THE INVENTION

Among the objects of the invention is a foam destabilizing additive for use in a water-borne film forming composition wherein the foam destabilizing additive is not classified as a volatile organic compound, but which, nevertheless, (i) exhibits foam destabilization, (ii) reduces surface tension, (iii) exhibits favorable adhesion and gloss relative to water borne film-forming compositions containing conventional foam destabilizing additives, (vi) exhibits favorable minimum film formation temperature of low glass transition temperature films and high glass transition temperature films and (v) produces coatings with little risk of surface defects, caused by the additive, such as craters.

Briefly, therefore, the present invention provides a film-forming composition comprising a continuous aqueous phase and a dispersed phase. The dispersed phase comprises (i) a particulate polymer or emulsified liquid prepolymer, and (ii) a foam destabilizing additive comprising an ester having the formula RCOOX wherein R and X are independently hydrocarbyl or substituted hydrocarbyl and at least one of R and X comprises at least two unsaturated carbon-carbon bonds.

The foam destabilizing additive is highly mobil and effective and, over time, is air oxidizes becoming an oligomer which would be less mobil and a more resin compatible component. Unlike mineral oil or silicone based defoamers, this foam destabilizing additive also can act as a coalescent aid in many latex resin based formulations. Additionally, this foam destabilizing additive can be made from natural or synthetic oils. The additive can potentially be used in water borne paints, cutting fluids, agricultural sprays, cleaning product compositions, and any application where foam suppression is desired. It can be added in the grind and/or in the letdown phase of film forming formula preparation.

Other objects of the invention will be in part apparent and in part pointed out hereinafter.

### DETAILED DESCRIPTION OF THE PREFERRED EMBODIMENTS

The water-borne film-forming compositions of the present invention generally contain a continuous aqueous phase and a dispersed film-forming phase. In general, they may be formulated to function as a paint, sealant, caulk, adhesive or other coating. Thus, these film-forming compositions may have a wide range of viscosities, e.g., from about 50 to about 10,000 centipoise; paints, sealants and similar coatings typically have a viscosity from about 50 to about 10,000 centipoise, caulks typically have a viscosity from about 5,000 to about 50,000 centipoise, and adhesives typically have a viscosity from about 50 to about 50,000 centipoise. In addition, adhesives are formulated for cohesive strength as well as good contact with the substrate upon which the film-forming composition is deposited.

The continuous aqueous phase generally comprises at least about 10 wt % water with the amount of water depending upon the application. For example, paints, sealants and similar coating compositions will generally have at least about 10 wt % water and typically will contain about 20 wt % to about 80 wt % water with differing amounts being used for textured, high gloss, semi-gloss, flat, etc. coatings. Caulks will generally have at least about 10 wt % water and typically will contain about 10 wt % to about 25 wt % water with differing amounts being used for different caulk applications. Adhesives will generally range from about 10 wt % to about 80 wt % water and typically will contain about 40 wt % to about 60 wt % water with differing amounts being used for different adhesive applications.

The continuous aqueous phase may optionally include one or more water-soluble organic solvents, i.e., substituted hydrocarbon solvents. For example, modest amounts of ethylene glycol (e.g., 35 wt. %) or another glycol may be included for freeze-thaw protection. In general, however, the proportion of water-soluble organic solvents is preferably minimized; that is, the continuous aqueous phase preferably contains less than about 20 wt. % organic solvent, more preferably less than about 10 wt. % organic solvent, and still more preferably less than about 5 wt. % organic solvent, based upon the weight of the continuous aqueous phase and exclusive of any amount which may be present in a micelle or other dispersed phase or material.

The dispersed phase comprises a (i) particulate polymer or an emulsified liquid pre-polymer, (ii) a foam destabilizing additive and, optionally, (iii) one or more additives. In general, the dispersed phase constitutes no more than about 90 wt % with the amount of dispersed phase depending upon the application. For example, paints, sealants and similar coating compositions will generally have no more than about 90 wt % dispersed phase and typically will contain about 20 wt % to about 80 wt % dispersed phase with differing amounts being used for textured, high gloss, semi-gloss, flat, etc. coatings. Caulks will generally have no more than about 90 wt % dispersed phase and typically will contain about 75 wt % to about 90 wt % dispersed phase with differing amounts being used for different caulk applications. Adhesives will generally range from about 20 wt % to about 90 wt % dispersed phase and typically will contain about 40 wt % to about 60 wt % dispersed phase with differing amounts being used for different adhesive applications.

In general, the particulate polymer or emulsified liquid pre-polymer is insoluble in the aqueous phase and is otherwise suitable for use in water borne film-forming compositions. Because the particulate polymer or emulsified liquid pre-polymer is the component which coalesces to form the desired film, the film-forming composition preferably comprises at least about 10 wt. %, more preferably at least about 15 wt. %, and depending for some applications at least about 20 wt. % of a coalescible particulate polymer or emulsified liquid pre-polymer.

Preferred particulate polymers are generally high molecular weight (e.g, greater than about 60,000 for latex), may be crosslinkable, polymer particles. For example, they may be either of the addition type, in particular a polymer or copolymer of one or more .alpha.,.beta.-ethylenically unsaturated monomers, or of the condensation type, for example, a polyester or a polyamide. Suitable particulate polymers of the addition type include the polymerization and copolymerization products of styrene, vinyl acetate, vinyl toluene, vinyl chloride, vinylidene chloride, butadiene, vinyl hydrocarbons, acrylonitrile, acrylates, and methacrylate containing monomers. Suitable condensation type particulate polymers include epoxy, urethane, hydrocarbon, silicone, nitrocellulose, polyester, and alkyd polymers. Preferred particulate polymers include acrylate, methacrylate, styrene and vinyl acetate. Examples of preferred particulate polymers include the polymerizates or copolymerizates of one or more of the following: alkyl acrylates such as ethyl acrylate, butyl acrylate, 2-ethylhexyl acrylate, as well as other alkyl acrylates, alkyl methacrylates, styrene and vinyl acetate.

In general, smaller particulate polymers are more readily coalesced than larger particulate polymers. Accordingly, preferred particulate polymers generally have a size of about 3 micrometers or less. For example, for latex resins, approximately 90 wt. % of the latex particles will have a size less than about 0.2 micrometers.

Preferred emulsified liquid pre-polymers include alkyds, epoxies, polyesters, nitrocellulose, and urethanes.

The foam destabilizing aid of the present invention preferably comprises an ester having the formula RCOOX wherein R is hydrocarbyl or substituted hydrocarbyl, X is hydrocarbyl or substituted hydrocarbyl, and at least one of R and X contains two or more aliphatic unsaturated carbon-carbon bonds (hereinafter “polyunsaturated”).

Preferably, R contains about 1 to about 30 carbon atoms, more preferably about 9 to about 25 carbon atoms, and still more preferably about 15 to about 23 carbon atoms, X contains about 1 to about 30 carbon atoms, more preferably about 1 to about 18 carbon atoms, and still more preferably about 1 to about 6 atoms, and R and X in combination contain no more than about 35 carbon atoms, and more preferably, R and X, in combination, contain no more than about 30 carbon atoms. In addition, at least one of R and X preferably contains a conjugated double or triple carbon-carbon bond (i.e., two or more carbon-carbon double or triple bonds which alternate with carbon-carbon single bonds). For example, the unsaturation may take the form of two conjugated double bonds, a conjugated double bond and triple bond or two conjugated triple bonds.

While the carbon-carbon polyunsaturation may be provided in R or X, it is generally preferred that it be provided at the tail of the ester, i.e., in R. Thus, R is preferably hydrocarbyl or substituted hydrocarbyl possessing at least two aliphatic unsaturated carbon-carbon bonds, more preferably in conjugation, with R preferably comprising about 5 to about 25 carbon, more preferably about 9 to about 25 carbon atoms, and still more preferably about 11 to about 23 carbon atoms. If R is substituted hydrocarbyl, it is preferably substituted with ketone, amide, ester, alcohol, urea, urethane, nitrile functionalities; silyl and amine functionalities are preferably avoided and alcohols are preferably avoided if the number of carbon atoms is less than about 10.

Optionally, the head of the ester, i.e., X, may be polyunsaturated instead of the tail of the ester. In this instance, X is preferably hydrocarbyl or substituted hydrocarbyl possessing at least two aliphatic unsaturated carbon-carbon bonds, more preferably in conjugation with X preferably comprising about 5 to about 30 carbon, more preferably about 5 to about 25 carbon atoms, and still more preferably about 5 to about 24 carbon atoms.

If R is polyunsaturated, X may optionally contain one or more degrees of carbon-carbon unsaturation. Stated another way, X may be hydrocarbyl or substituted hydrocarbyl optionally possessing one or more degrees of carbon-carbon unsaturation. As with R, X may optionally contain at least 2 degrees of carbon-carbon unsaturation with the 2 degrees of carbon-carbon unsaturation optionally being in conjugation. In one embodiment of the present invention, for example, X is X′—OH wherein X′ is a hydrocarbyl or substituted hydrocarbyl radical comprising about 1 to about 8 carbon atoms. Preferably, X′comprises about 2 to about 6 carbon atoms and, in one embodiment X′ possesses at least one degree of unsaturation. If X or X′ is substituted hydrocarbyl, it is preferably substituted with ketone, amide, ester, alcohol, urea, urethane, nitrile functionalities.

The polyunsaturated ester of the present invention is preferably sufficiently involatile to avoid categorization as a Volatile Organic Compound by the United States Environmental Protection Agency. In one embodiment of the present invention, the foam destabilizing aid is a single ester. In another embodiment of the present invention, the foam destabilizing aid comprises a mixture of esters with at least one of the esters being a polyunsaturate. In a third embodiment, the foam destabilizing aid comprises a polyunsaturated ester with conventional defoamers such as mineral oil or silicones. Where composition(s) other than polyunsaturated esters are also used as a foam destabilizing aid, it is generally preferred that the polyunsaturated ester comprise at least about 5 wt. %, more preferably at least about 10 wt. %, still more preferably at least about 25 wt. %, still more preferably at least about 50 wt. %, and still more preferably at least about 75 wt. %, based upon the total combined weights of the compositions used as foam destabilizing aids.

The polyunsaturated ester of the present invention may be derived from a natural, genetically engineered or synthetic material such as an oil, fat, lecithin or petroleum product. In a preferred embodiment, the foam destabilizing additive comprises a polyunsaturated ester derived from an oil of plant or animal origin (including oils obtained from genetically engineered species), such as canola, linseed, soybean, or another naturally occurring oil such as one identified in Table I. Examples of preferred polyunsaturated esters include methyl ester, ethylene glycol monoester, diethylene glycol monoester, propylene glycol monoester, and dipropylene glycol monoester derived from the fatty acids of these oils.

TABLE I

| VEGETABLE OIL | AVERAGE FATTY ACID AS PERCENT OF TOTAL FATTY ACID | | | | | | | | | | | | | | |
|---|---|---|---|---|---|---|---|---|---|---|---|---|---|---|---|
| Number of Carbon Atoms | — | 6 | 10 | 12 | 14 | 16 | 18 | 18 | 18 | 18 | 16 | 18 | 22 | 20-22 | 20-24 |
| Number of Double Bonds | | 0 | 0 | 0 | 0 | 0 | 0 | 1 | 2 | 3 | 1 | 1 | 1 | ** | 3 |
| Castor | 85 | | | | | 1.0 | 2.0 | 2.0 | 5.0 | | | 90.0 | | | |
| Corn | 124 | | | | | 13.0 | 4.0 | 29.0 | 54.0 | | | | | | |
| Cottonseed | 107 | | | | | 22.0 | 2.0 | 21.0 | 54.0 | | | | | | |
| Cmmbe | 94 | | | | | 3.0 | 2.0 | 18.0 | 10.0 | 5.0 | | | 56.0 | 3.0 | 2.0 |
| Linseed | 185 | | | | | 6.0 | 4.0 | 20.0 | 17.0 | 53.0 | | | | | |
| Mustard | 120 | | | | | 2.0 | | 24.0 | 20.0 | 6.0 | | | 43.0 | | 5.0 |
| Olive | 80 | | | | | 8.0 | 2.0 | 82.0 | 8.0 | | | | | | |
| Oiticica¹ | 150 | | | | | 7.0 | 6.0 | 5.0 | | | | | | | |
| Peanut | 90 | | | | | 7.0 | 6.0 | 60.0 | 22.0 | | | | | | 5.0 |
| Rapeseed | 101 | | | | | 2.0 | 2.0 | 16.0 | 16.0 | 8.0 | | | 45.0 | 6.0 | 4.0 |
| Rice Bran | 102 | | | | | 17.0 | 1.0 | 47.0 | 35.0 | | | | | | |
| Safflower | 141 | | | | | 6.0 | 2.0 | 13.0 | 79.0 | | | | | | |
| Sardine, Pilchard | 190 | | | | | 14.0 | 3.0 | 10.0 | 15.0 | | 12.0 | | | 41.0 | |
| Sesame | 110 | | | | | 9.0 | 4.0 | 46.0 | 41.0 | | | | | | |
| Soybean | 130 | | | | | 8.0 | 6.0 | 28.0 | 50.0 | 8.0 | | | | | |
| Sunflower | 139 | | | | | 6.0 | 2.0 | 26.0 | 66.0 | | | | | | |
| Tung (Regular)² | 165 | | | | | 4.0 | 1.0 | 5.0 | 8.0 | | | | | | |
| Tung (African)³ | 160 | | | | | 4.0 | 1.0 | 9.0 | 15.0 | | | | | | |
| Walnut (English) | 150 | | | | | 9.0 | 1.0 | 16.0 | 60.0 | 13.0 | | | | | |

* Iodine Number;
** polyethenoic acids;
¹contains 82% licanic acid;
²contains 82% eleostearic acid;
³contains 71% elestcaric acid

The fatty acid ester glycols may be prepared by transesterification reactions between various glycols and fatty acids from soybean and other oils of plant or animal origin in the presence of a catalyst. Suitable catalysts include bases such as lithium hydroxide, tin oxides, tin catalysts, and calcium oxide with the reaction temperature generally being about 100 to about 200° C. In a preferred embodiment, the glycol used in the reaction is ethylene glycol, propylene glycol, diethylene glycol or dipropylene glycol with the reaction being carried out with about 6 moles of glycol per mole of soybean oil in the presence of a basic catalyst at a temperature of about 190® C. under nitrogen atmosphere. After reaction, the excess glycol is extracted with water several times. The soy oil ester is extracted with ethyl ether and dried, for example, with magnesium sulfate. Then the ethyl ether is distilled off. The reaction equation is given below

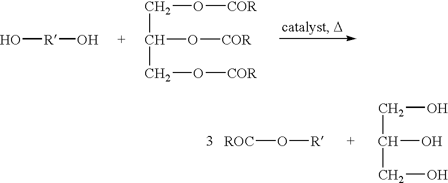

where R is unsaturated hydrocarbon chain having 17 carbons.

R′ is a group of the formula —C2H4- for ethylene glycol —C3H6- for propylene glycol —C2H4O—C2H4- for diethylene glycol —C3H6O—C3H6- for dipropylene glycol.

The amount of foam destabilizing additive needed depends on the viscosity of the film-forming composition, the temperature at which the composition is being applied, the surface tension, and where it is added in the formulation preparation, i.e. in the grind versus in the letdown phase. In general, the amount of foam destabilizing additive is in the range of about 0.05 wt % to about 5 wt. % (based upon the weight of the dry resin), typically in the 1 wt. % to about 4 wt. % range (based upon the weight of resin).

The foam destabilizing additive which remains in the film will act as a plasticizer, keeping the glass transition temperature low unless it has polyunsaturation which will allow it to be air oxidized and oligomerized which results in the foam destabilizing additive becoming more of a resin and less of a plasticizer. Thus, the glass transition temperature is in part recovered. In general, the greater degree of unsaturation of the foam destabilizing additive the more glass transition temperature recovery can be expected. Where a mixture of materials are used as the foam destabilizing additive, therefore, it is generally preferred that the polyunsaturated acid(s) comprise at least about 5 wt. %, more preferably at least about 25 wt. %, still more preferably at least about 40 wt. % and still more preferably at least about 50 wt. % of the foam destabilizing additive.

The film-forming composition of the present invention may also contain various conventional additives which may be in the dispersed and/or continuous phases. Such additives include thickening agents such as carboxymethylcellulose sold by Aquilon under the trade designation Natrasol 250 and thickeners sold under the trade designation M-P-A 1075 by Rheox, pH modifiers such as ammonium hydroxide and N,N-dimethyl ethanolamine, coalescing agents such as Archer RC, wetting agents such as a nonionic surfactant sold by AKZO under the trade designation Interwet 43 and a nonionic surfactant sold by Rohm & Haas under the trade designation Triton X100, algicides such as organotin compounds and tetrachloroisophthalonitrile, fungicides such as tributyl tin oxide, and 3-iodo-2-proynyl butyl carbamate, dispersants such as lecithin and an anionic dispersant sold under the trade designation Busperse 39 by Buckman, ultraviolet inhibitors such as a benztriazol UV inhibitor sold under the trade designation Tinuvin 328 by Ciba-Geigy and a hindered amine UV inhibitor sold under the trade designation by Tinuvin 123 by Ciba-Geigy, flow and leveling agents such as a polyacrylate sold under the trade designation Byk 354 by Byk-Chemie and a polysiloxane copolymer sold under the trade designation Byk 310 by Byk-Chemie, flash rust inhibitors such as an inhibitor sold under the trade designation Raybo 63 by Raybo or a barium metaborate rust inhibitor sold under the trade designation Busan 11 ml by Buckman, and freeze/thaw inhibitors such as ethylene glycol. When present and depending upon the application for the film-forming composition, these additives will generally not constitute more than about 10 wt. % of the film-forming composition and will typically constitute about 3 wt. % to about 10 wt. % of the film-forming composition.

The film-forming composition is formed by conventional methods used to prepare paints, adhesives, except that the polyunsaturated ester of the present invention is substituted, at least in part, for a conventional foam destabilizing additive. The resulting film-forming composition can easily be applied conventionally using a brush, roller, or like means and requires no unusual methods of drying to form the desired film. Thus, films formed from the composition of the present invention may be dried under ambient conditions. Furthermore, the film-forming composition may be applied to a variety of materials.

### DEFINITIONS

As used herein, the term “hydrocarbyl” shall mean a radical consisting exclusively of carbon and hydrogen. The hydrocarbyl may be branched or unbranched, saturated or unsaturated. Suitable hydrocarbyl moieties include alkyl, alkenyl, alkynyl, and aryl moieties. They also include alkyl, alkenyl, alkynyl, and aryl moieties substituted with other saturated or unsaturated hydrocarbyl moieties such as alkaryl, alkenaryl and alkynaryl. Preferably, the hydrocarbyl does not include an aryl moiety and except as otherwise indicated herein, the hydrocarbyl moieties preferably comprises up to about 25 carbon atoms.

The aryl moieties described herein contain from 6 to 20 carbon atoms and include phenyl. They may be hydrocarbyl substituted with the various substituents defined herein. Phenyl is the more preferred aryl.

The term “substituted hydrocarbyl” shall mean a hydrocarbyl radical wherein at least one hydrogen atom has been substituted with an atom other than hydrogen or carbon, including moieties in which a carbon chain atom is substituted with a hetero atom such as nitrogen, oxygen, silicon, phosphorous, boron, sulfur, or a halogen atom. These substituents include hydroxy; lower alkoxy such as methoxy, ethoxy, butoxy; halogen such as chloro or fluoro; ethers; esters; heteroaryl such as furyl or thienyl; alkanoxy; acyl; acyloxy; nitro; amino; and amido.

The acyl moieties and the acyloxy moieties described herein contain hydrocarbyl, substituted hydrocarbyl or heteroaryl moieties. In general, they have the formulas —C(O)G and —OC(O)G, respectively, wherein G is substituted or unsubstituted hydrocarbyl, hydrocarbyloxy, hydrocarbylamino, hydrocarbylthio or heteroaryl.

This invention will be further illustrated by the following Examples although it will be understood that these Examples are included merely for purposes of illustration and are not intended to limit the scope of the invention.

### EXAMPLES

### Test Procedures

The following test procedures were used to generate the data reported in the examples below:

### Surface Tension

Surface tension was determined by the ring method tensiometer according to ASTM D 1331-89. The data presented here is in relative units. The extension is in units of seconds which is proportional to the lamella length. The H value is in mm as the peak force reached and is proportional to the actual surface tension.

### Hydrophilic Lipophilic Balance

Hydrophilic lipophilic balance (HLB) values were calculated from equation 1 based on ethylene oxide moiety in the molecule. HLB=% Hydrophile by weight of molecule/5.

Solubility parameter values were calculated according to the Hansen Method from the Handbook of Solubility Parameters.

### Density

Density was determined according to ASTM D-1475.

### Example 1

Solutions were prepared by placing the surfactants listed below in water at the concentrations listed. The defoamer was added at the level listed and mixed. The surface tension was then measured.

For Triton X-100, The Archer proved to be more effective at reducing the lamella length which is a measure of foam stability and also was effective at reducing the surface tension.

Foam Stability in Water

| | | |
|---|---|---|
| X-100 | 0.5% | 0.5% |
| Archer | 1.0% | 0% |
| Height(mm) | 30.0 | 36.0 |
| Time(sec) | 230.0 | 155.0 |
| X-100 | 0.5% | 0.5% |
| Archer | 2.0% | 0% |
| Height(mm) | 23.0 | 36.0 |
| Time(sec) | 190.0 | 155.0 |
| X-100 | 0.5% | 0.5% |
| Drew | 1.0% | 0% |
| Height(mm) | 20.0 | 36.0 |
| Time(sec) | 367.0 | 155.0 |
| X-100 | 0.5% | 0.5% |
| Drew | 2.0% | 0% |
| Height(mm) | 23.0 | 36.0 |
| Time(sec) | 330.0 | 155.0 |
| * layer formed | | |
| X-100 | 1.0% | 1.0% |
| Archer | 1.0% | 0% |
| Height(mm) | 25.0 | 36.0 |
| Time(sec) | 200.0 | 155.0 |

When Archer was used at the 1% level with the X-35, X57 or X102 as the surfactant at the 1% level, the surfactant strengthened the foam in the case of X-35 but weakened the lamella in X-57 with little effect on X102. The selective effect of the defoamer on varying HLB surfactants is not unexpected since the general structure of the defoamer yields an HLB value of that shown below

| Surfactant | HLB Value |
|---|---|
| X-100 | 13.5 |
| X-35 | 7.8 |
| X-57 | 10.0 |
| X-102 | 14.6 |

| | | |
|---|---|---|
| X-35 | 1.0% | 1.0% |
| Archer | 1.0% | 0% |
| Height(mm) | 30.0 | 21.0 |
| Time(sec) | 170.0 | 105.0 |
| X-57 | 1.0% | 1.0% |
| Archer | 1.0% | 0% |
| Height(mm) | 28.0 | 27.0 |
| Time(sec) | 125.0 | 165.0 |
| X-102 | 1.0% | 1.0% |
| Archer | 1.0% | 0% |
| Height(mm) | 36.0 | 36.0 |
| Time(sec) | 140.0 | 145.0 |

### Example 2

| | | 1st | 2nd | 3rd | Average |
|---|---|---|---|---|---|
| UCAR 435 | Height(mm) | 41 | 38 | 34 | 37.7 |
| (control) | Time(sec) | 248 | 320 | 238 | 268.7 |
| UCAR 435 | height(mm) | 40 | 40 | | 40.0 |
| 1% DEB | time(sec) | 230 | 240 | | 235.0 |
| UCAR 435 | height(mm) | 36 | 35 | 37 | 36.0 |
| 2% DEB | time(sec) | 245 | 260 | 260 | 255.0 |
| UCAR 435 | height(mm) | 26 | 41 | 40 | 35.7 |
| 1% EB | time(sec) | 170 | 220 | 221 | 203.7 |
| UCAR 435 | height(mm) | 38 | 38 | | 38.0 |
| 2% EB | time(sec) | 270 | 260 | | 265.0 |
| UCAR 435 | height(mm) | 38 | 37 | 40 | 38.3 |
| 1% Texanol | time(sec) | 285 | 212 | 250 | 249.0 |
| UCAR 435 | height(mm) | 32 | 37 | 36 | 35.0 |
| 2% Texanol | time(sec) | 360 | 235 | 220 | 271.7 |
| UCAR 435 | height(mm) | 39 | 34 | 34 | 35.7 |
| 1% Archer | time(sec) | 200 | 205 | 215 | 206.7 |
| UCAR 435 | height(mm) | 36 | 34 | 35 | 35.0 |
| 2% Archer | time(sec) | 205 | 205 | 200 | 203.3 |

### Example 3

| | | | | | |
|---|---|---|---|---|---|
| Flexbond 325 | height(mm) | 35 | 35 | 45 | 38.3 |
| (control) | time(sec) | 220 | 230 | 200 | 216.7 |
| Flexbond 325 | height(mm) | 29 | 41 | 51 | 40.3 |
| 1% DEB | time(sec) | 205 | 208 | 182 | 198.3 |
| Flexbond 325 | height(mm) | 34 | 38 | 40 | 37.3 |
| 2% DEB | time(sec) | 185 | 200 | 170 | 185.0 |
| Flexbond 325 | height(mm) | 30 | 27 | 32 | 29.7 |
| 1% EB | time(sec) | 200 | 170 | 195 | 188.3 |
| Flexbond 325 | height(mm) | 38 | 35 | 36 | 36.3 |
| 2% EB | time(sec) | 190 | 185 | 170 | 181.7 |
| Flexbond 325 | height(mm) | 31 | 32 | 34 | 32.3 |
| 1% Texanol | time(sec) | 175 | 215 | 180 | 190.0 |
| Flexbond 325 | height(mm) | 36 | 35 | 34 | 35.0 |
| 2% Texanol | time(sec) | 215 | 185 | 180 | 193.3 |
| Flexbond 325 | height(mm) | 40 | 35 | 33 | 36.0 |
| 1% Archer | time(sec) | 200 | 190 | 170 | 186.7 |
| Flexbond 325 | height(mm) | 30 | 30 | | 30.0 |
| 2% Archer | time(sec) | 170 | 175 | | 172.5 |

### Example 4

| | | | | | |
|---|---|---|---|---|---|
| UCAR 626 | height(mm) | 41 | 36 | 36 | 37.7 |
| (control) | time(sec) | 375 | 290 | 310 | 325.0 |
| UCAR 626 | height(mm) | 33 | 34 | 34 | 33.7 |
| 1% DEB | time(sec) | 340 | 280 | 350 | 323.3 |
| UCAR 626 | height(mm) | 31 | 31 | 31 | 31.0 |
| 2% DEB | time(sec) | 310 | 340 | 360 | 336.7 |
| UCAR 626 | height(mm) | 29 | 31 | | 30.0 |
| 1% EB | time(sec) | 180 | 190 | | 185.0 |
| UCAR 626 | height(mm) | 44 | 39 | 46 | 43.0 |
| 2% EB | time(sec) | 305 | 325 | 300 | 310.0 |
| UCAR 626 | height(mm) | 40 | 44 | 40 | 41.3 |
| 1% Texanol | time(sec) | 300 | 245 | 310 | 285.0 |
| UCAR 626 | height(mm) | 39 | 39 | 39 | 39.0 |
| 2% Texanol | time(sec) | 260 | 240 | 210 | 236.7 |
| UCAR 626 | height(mm) | 35 | 35 | 33 | 34.3 |
| 1% Archer | time(sec) | 280 | 310 | 340 | 310.0 |
| UCAR 626 | height(mm) | 35 | 35 | 33 | 34.3 |
| 2% Archer | time(sec) | 250 | 275 | 280 | 268.3 |

### Paint Formulations

Paint Formula 1
Propylene glycol monoester of Sunflower oil
(Archer RC) as the Foam Destabilizing Additive

| Component | Grams |
|---|---|
| Grind phase | |
| Water | 105.00 |
| Bentone LT | 3.50 |
| Tamol 681 | 12.60 |
| Triton CF-10 | 1.75 |
| AMP 95 | 1.40 |
| Polyphobe TR117 | 1.40 |
| Archer RC | 2.10 |
| CR 822 | 126.00 |
| Minex 7 | 70.00 |
| Grind for 30 min. | |
| Letdown phase | |
| UCAR 435 | 357.00 |
| Archer RC | 8.40 |
| AMP 95 | 1.05 |
| RM825 | 2.10 |

Paint Formula 2
Standard Using Patco 520 as the Foam Destabilizing Additive

| Component | Grams |
|---|---|
| Grind phase | |
| Water | 105.00 |
| Bentone LT | 3.50 |
| Tamol 681 | 12.60 |
| Triton CF-10 | 1.75 |
| AMP 95 | 1.40 |
| Polyphobe TR117 | 1.40 |
| Patco 520 | 2.10 |
| CR 822 | 126.00 |
| Minex 7 | 70.00 |
| Grind for 30 min. | |
| Letdown phase | |
| UCAR 435 | 357.00 |
| IBT Filmer | 10.50 |
| AMP 95 | 1.05 |
| RM825 | 2.10 |

Paint Formula 3
Control Using No Foam Destabilizing Additive

| Component | Grams |
|---|---|
| Grind phase | |
| Water | 105.00 |
| Bentone LT | 3.50 |
| Tamol 681 | 12.60 |
| Triton CF-10 | 1.75 |
| AMP 95 | 1.40 |
| Polyphobe TR117 | 1.40 |
| CR 822 | 126.00 |
| Minex 7 | 70.00 |
| Grind for 30 min. | |
| Letdown phase | |
| UCAR 435 | 357.00 |
| IBT Filmer | 10.50 |
| AMP 95 | 1.05 |
| RM825 | 2.10 |

Three paints were prepared as shown in formula 1-3. A high speed disperser blade was used at 4,000 rpm for 30 minutes. The Stormer viscosity and density were then measured. The 600 g of the paints were then placed in 1 pint cans and shaken for 3 minutes on a paint shaker. When removed from the shaker the cans were rolled at 1 rpm for 15 minutes. The paint cans were opened immediately and the density of the paint determined. The Archer additive reduced the amount of foam to a similar level to the control relative to no defoamer. A second foam stability test was run by taking the same paint after 24 hours and stirring each can by hand vigerously for 3 minutes. The paints density was then measured. The Archer additive incorporated less air than the standard or the one with no defoamer. The data for the tests are shown below.

Surface Tension Paint Formulas 1-3

| | Formula 1 | Formula 2 | Formula 3 |
|---|---|---|---|
| Trial | H/T | H/T | H/T |
| Trial 1 | 28/210 | 28/360 | 27/350 |
| Trial 2 | 27/230 | 27/300 | 28/350 |
| Trial 3 | 28/235 | 27/310 | 23/340 |
| Average | 28/225 | 27/323 | 26/347 |

H is the maximum force exerted on the ring. T is the length of the lamella.

What is claimed is:

1. A film-forming composition comprising a continuous aqueous phase and a dispersed phase, the dispersed phase comprising (i) a particulate polymer or emulsified liquid prepolymer, and (ii) a foam destabilizing additive comprising an ester derived from a fatty acid of an oil of plant or animal origin, the ester having the formula RCOOX wherein R is hydrocarbyl or substituted hydrocarbyl and comprises at least two unsaturated carbon-carbon bonds and X is —C2H4OH, —C2H4OC2H 4OH, —C3H6OH, or —C3H6OC3H6OH, whereby air oxidation of the additive causes oligomerization of the additive in the presence of air.

2. The film-forming composition of claim 1 wherein the foam destabilizing additive is derived from corn oil, sunflower oil, safflower oil, soybean oil, canola oil, or linseed oil.

3. The film-forming composition of claim 1 wherein the dispersed or continuous aqueous phase further comprises an additive selected from the group consisting of wetting aids, dispersants, thickeners, defoaming agents, biocides, algicides, ultra-violet inhibitors, flow agents, leveling agents, reology modifiers, freeze thaw stabilizing agents, pH modifiers, flash rust inhibitors, and biocides.

4. A film-forming composition of claim 1 wherein the foam destabilizing additive is added in the grind stage at 0.05 to 5% level.

5. A film-forming composition of claim 1 wherein the foam destabilizing additive is added in the letdown stage at 0.05 to 5% level.

6. A film-forming composition of claim 1 wherein the foam destabilizing additive is added in the grind stage at 0.05 to 2.5% level and also during letdown at the 0.05 to 2.5% level.
